(19) United States
(12) Patent Application Publication
(10) Pub. No.: US 2025/0046829 A1
(43) Pub. Date: Feb. 6, 2025

(54) SEPARATOR FOR FUEL CELL AND FUEL CELL INCLUDING SAME

(71) Applicant: University of Seoul Industry Cooperation Foundation, Seoul (KR)

(72) Inventors: Young Seung NA, Seoul (KR); Cho Eun KIM, Seoul (KR)

(21) Appl. No.: 18/778,199

(22) Filed: Jul. 19, 2024

(30) Foreign Application Priority Data
Aug. 4, 2023 (KR) 10-2023-0102262

(51) Int. Cl. H01M 8/0263; H01M 8/04119

(52) U.S. Cl. CPC H01M 8/0263; H01M 8/04149

(57) ABSTRACT

Disclosed are a separator which can prevent deterioration due to non-uniform current density distribution by uniformly supplying reactants without increasing the size of the separator, and a fuel cell including the same. The disclosed separator includes: a body plate; an inlet formed in one side of the body plate; an outlet formed in the other side of the body plate; a first meandering flow path formed by being connected to the inlet; a second meandering flow path formed by being connected to the outlet; and a parallel flow path formed between the first meandering flow path and the second meandering flow path.

### CROSS-REFERENCE TO RELATED APPLICATION

This application claims priority to Korean Patent Application No. 10-2023-0102262, filed on Aug. 4, 2023, the disclosure of which is incorporated by reference herein in its entirety.

### TECHNICAL FIELD

The present disclosure relates to a separator for a fuel cell, which can prevent deterioration due to non-uniform current density distribution by uniformly supplying reactants without increasing the size, and a fuel cell including the same.

### BACKGROUND

Types of fuel cells include molten carbonate fuel cells (MCFCs) and solid oxide fuel cells (SOFCs), which operate at a high temperature of 600 degrees Celsius or higher, and phosphoric acid fuel cells (PAFCs) and polymer electrolyte fuel cells (PEFCs), which operate at a relatively low temperature of 200 degrees Celsius or lower.

FIG. 1 is an exploded perspective view showing a typical polymer electrolyte membrane fuel cell.

As shown in FIG. 1, the polymer electrolyte membrane fuel cell 100 includes a plurality of unit cells 110 and fastening plates 120 and 130 disposed outside the stacked unit cells 110. The unit cells 110 include membrane electrode assemblies 111 and separators 112 disposed on both sides thereof, and the plurality of unit cells 110 are stacked and arranged between the fastening plates (end plates) 120 and 130. A gas diffusion layer (GDL) 113 is disposed between the membrane electrode assembly 111 and the separator 112.

With reference to FIGS. 2 to 5, the separators according to the related arts and their problems will be described.

Referring to FIG. 2, the conventional separator 112_1 has an inlet 112a formed in one side thereof and an outlet 112b formed in the other side thereof, and the inlet 112a and the outlet 112b is provided with a flow space formed by being connected with one meandering flow path 112c.

Such a conventional separator 112_1 has a problem in that a large pressure drop occurs as reactants flow along one long meandering flow path 112c, resulting in an increase in power consumption required for operation.

To solve such a problem, a separator as shown in FIG. 3 was devised. Referring to FIG. 3, the conventional separator 112_2 has an inlet 112a formed in one side thereof and an outlet 112b formed in the other side thereof, and the inlet 112a and the outlet 112b are provided with a flow space formed by being connected with a plurality of parallel flow paths 112d.

Although such a conventional separator 112_2 has shortened the flow path between the inlet 112a and the outlet 112b, thereby reducing the pressure drop, a problem of deteriorating the current density occurs as the amount of reactants flowing through the plurality of parallel flow paths 112d becomes non-uniform.

That is, as shown in FIG. 4, the amount of reactants flowing through the parallel flow path region (A) close to the inlet 112a and the parallel flow path region (B) close to the outlet 112b becomes very large compared to the amount of reactants flowing through the region (C) between them so that there is a problem in that the amount of reactants flowing through all parallel flow paths 112d becomes non-uniform.

In order to solve this problem, as shown in FIG. 5, a method of installing an inlet distribution flow path 112e and an outlet distribution flow path 112f for distributing reactants on the inlet 112a and outlet 112b sides has been devised, but there are problems in that the additionally installed distribution flow paths 112e and 112f cause the volume and weight of the fuel cell to increase, which reduces usability and increases manufacturing costs.

### SUMMARY

An object of the present disclosure is to provide a separator for a fuel cell, which can prevent deterioration due to non-uniform current density distribution by uniformly supplying reactants without increasing the size, and a fuel cell including the same.

A separator for a fuel cell according to an embodiment of the present disclosure includes: a body plate; an inlet formed in one side of the body plate; an outlet formed in the other side of the body plate; a first meandering flow path formed by being connected to the inlet; a second meandering flow path formed by being connected to the outlet; and a parallel flow path formed between the first meandering flow path and the second meandering flow path.

In the separator for a fuel cell according to an embodiment of the present disclosure, the first meandering flow path and the second meandering flow path may be formed to have a flow resistance greater than that of the parallel flow path.

In the separator for a fuel cell according to an embodiment of the present disclosure, the first meandering flow path and the second meandering flow path may be formed to have a flow length longer than that of the parallel flow path.

In the separator for a fuel cell according to an embodiment of the present disclosure, the first meandering flow path and the second meandering flow path are flow paths that connect a distribution flow path formed in the inlet side and a confluence flow path formed in the outlet side, and are formed by being bent at least twice. The parallel flow path is a flow path that connects the distribution flow path formed in the inlet side and the confluence flow path formed in the outlet side, and is formed without being bent.

In the separator for a fuel cell according to an embodiment of the present disclosure, the first meandering flow path and the second meandering flow path are flow paths formed in a zigzag shape connecting the distribution flow path formed in the inlet side and the confluence flow path formed in the outlet side, and may be formed by being bent at least twice.

Furthermore, a separator for a fuel cell according to an embodiment of the present disclosure includes: a body plate; an inlet formed in the center of one side of the body plate; an outlet formed in the other side of the body plate at a position opposite to the inlet; a meandering flow path formed by being connected to the inlet and the outlet; and parallel flow paths formed in both sides of the meandering flow path.

In the separator for a fuel cell according to an embodiment of the present disclosure, the meandering flow path may be formed to have a flow resistance greater than those of the parallel flow paths.

In the separator for a fuel cell according to an embodiment of the present disclosure, the meandering flow path may be formed to have a flow length longer than those of the parallel flow paths.

In the separator for a fuel cell according to an embodiment of the present disclosure, the meandering flow path is a flow path that connects the distribution flow path formed in the inlet side and the confluence flow path formed in the outlet side, and is formed by being bent at least twice. The parallel flow paths are flow paths that connect the distribution flow path formed in the inlet side and the confluence flow path formed in the outlet side, and may be formed without being bent.

A fuel cell according to an embodiment of the present disclosure includes: a membrane-electrode assembly including a cathode electrode, an anode electrode, and a membrane between the cathode electrode and the anode electrode; a cathode electrode separator which is stacked on the membrane-electrode assembly and in which a flow path for air or oxygen is formed; and a gas diffusion layer interposed between the electrode separator and the membrane-electrode assembly. Here, the cathode electrode separator is characterized by being the above-described separator for a fuel cell according to an embodiment of the present disclosure.

Details of other embodiments according to various aspects of the present disclosure are included in the detailed description below.

According to an embodiment of the present disclosure, it is possible to uniformly supply reactants in all channels. Therefore, it is possible to uniformly supply reactants without increasing the size of the separator, thereby preventing deterioration due to non-uniform current density distribution.

### BRIEF DESCRIPTION OF THE DRAWINGS

FIG. 1 is an exploded perspective view showing a typical polymer electrolyte membrane fuel cell.

FIGS. 2, 3, 4 and 5 are plan views showing separators for a fuel cell according to the related arts.

FIG. 6 is a plan view showing a separator for a fuel cell according to one embodiment of the present disclosure.

FIG. 7 is a drawing for comparing and explaining the current densities in the separator for a fuel cell of the related art and the separator for a fuel cell of the present disclosure.

FIG. 8 is a drawing for comparing and explaining the mass flow rate for each channel in the separator for a fuel cell of the related art and the separator for a fuel cell of the present disclosure.

FIG. 9 is a plan view showing a separator for a fuel cell according to another embodiment of the present disclosure.

FIGS. 10 and 11 are plan views conceptually illustrating application examples of separators for a fuel cell according to embodiments of the present disclosure.

### DETAILED DESCRIPTION

Since the present disclosure can be modified in various ways and can have various embodiments, specific embodiments will be exemplified and explained in detail in the detailed description. However, this is not intended to limit the present disclosure to specific embodiments, and should be understood to include all conversions, equivalents, and substitutes included in the spirit and technical scope of the present disclosure.

The terms used in the present disclosure are only used to describe specific embodiments and are not intended to limit the present disclosure. Singular expressions include plural expressions unless the context clearly dictates otherwise. In the present disclosure, terms such as ‘include’ or ‘have’ are intended to designate the presence of features, numbers, steps, operations, components, parts, or combinations thereof described in the specification, but it should be understood that this does not exclude in advance the possibility of the presence or addition of one or more other features, numbers, steps, operations, components, parts, or combinations thereof. Hereinafter, a separator for a fuel cell according to an embodiment of the present disclosure and a fuel cell including the same will be described with reference to the drawings.

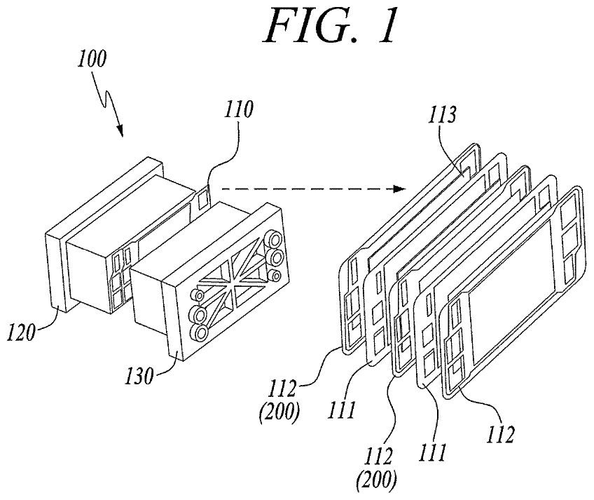

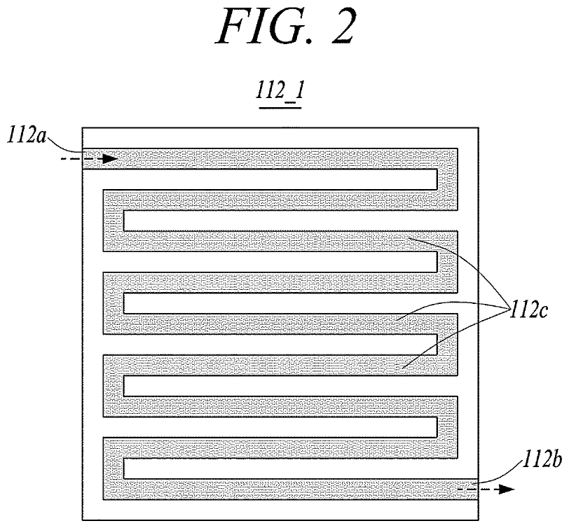

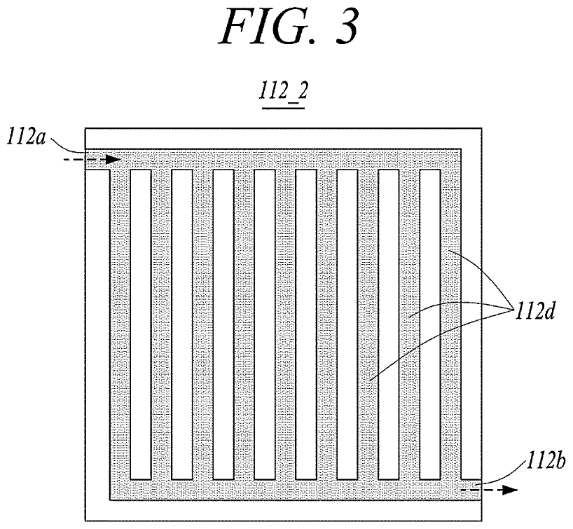

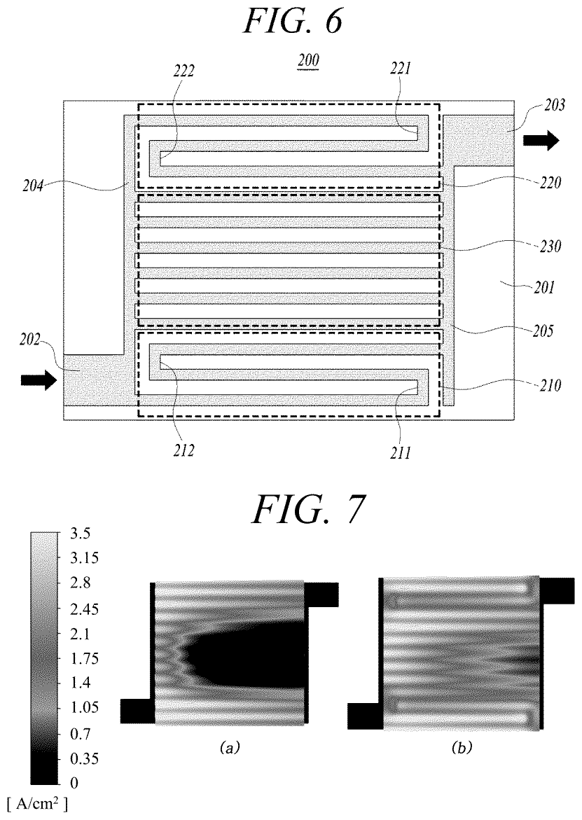

First, referring again to FIG. 1, a fuel cell 100 including metal separators 200 for a fuel cell according to embodiments of the present disclosure will be described. The fuel cell 100 includes a plurality of unit cells 110 and fastening plates 120 and 130 disposed outside the stacked unit cells 110. The unit cells 110 include a membrane electrode assembly 111 and separators 200 disposed on both sides thereof, and the plurality of unit cells 110 are stacked and arranged between the fastening plates 120 and 130. A gas diffusion layer 113 is disposed between the membrane electrode assembly 111 and the separator 200. In embodiments of the present disclosure, the separators 200 are provided in forms that are shown in FIGS. 6, 9, 10, and 11 to prevent deterioration due to non-uniform current density distribution by supplying reactants uniformly without increasing the size, and this will be described later.

The membrane electrode assembly 111 is formed in a typical structure including an electrolyte membrane, an anode electrode, and a cathode electrode. The electrolyte membrane is a polymer electrolyte formed to a thickness of approximately 5 μm to 200 μm, and has an ion exchange function to move hydrogen ions generated at the anode electrode to the cathode electrode. In this embodiment, the fuel cell 100 is illustrated as being made of a polymer electrolyte fuel cell, but the present disclosure is not limited thereto, and the present disclosure may be applied to various types of fuel cells.

An oxidizer inlet port and a fuel inlet port may be formed in one of the fastening plates 120 and 130, and an oxidizer outlet port and a fuel outlet port may be formed in the other fastening plate. Alternatively, an oxidizer inlet port, a fuel inlet port, an oxidizer outlet port, and a fuel outlet port may all be formed in one of the fastening plates 120 and 130. The fastening plates 120 and 130 may include a current collector plate for collecting current and an insulating plate for insulation.

Fuel may be supplied to the unit cells 110 through the fastening plates 120 and 130 and may be supplied to the anode electrode through a flow channel formed in the separator 200. In addition, the oxidizer may be supplied to the unit cells 110 through the fastening plates 120 and 130 and may be supplied to the cathode electrode through a flow channel formed in the separator 200.

Here, the oxidizer may be formed of oxygen-containing air or pure oxygen, and the fuel may be formed of hydrogen or a hydrocarbon-based fuel containing hydrogen. In this specification, the oxidizer and fuel are collectively referred to as fluid. Fuel or oxidant may flow through the flow channel 230 depending on the position of the separator 200.

FIG. 6 is a plan view showing a separator according to one embodiment of the present disclosure. The separator shown in FIG. 6 is a cathode electrode separator, and hereinafter, reference numeral 200 will be used for the cathode electrode separator.

Referring to FIG. 6, the separator 200 according to one embodiment of the present disclosure includes a body plate 201, an inlet 202, an outlet 203, a first meandering flow path 210, and a second meandering flow path 220, and a parallel flow path 230.

The body plate 201 is a plate member of a predetermined shape. The body plate 201 may be formed in a shape corresponding to the shape formed by the flow paths 210, 220, and 230. The inlet 202, the outlet 203, and the flow paths 210, 220, and 230 may be engraved patterns formed on the surface of the body plate 201.

The inlet 202 is a flow path into which externally supplied air or oxygen flows, and the outlet 203 is a flow path through which products and unconsumed reactants flowing through the flow paths 210, 220, and 230 flow out. The inlet 202 is formed in one side of the body plate 201, and the outlet 203 is formed in the other side of the body plate 201. The flow paths 210, 220, and 230 connecting them are formed between the inlet 202 and the outlet 203.

Specifically, the first meandering flow path 210 is formed by being connected to the inlet 202, the second meandering flow path 220 is formed by being connected to the outlet 203, and a plurality of parallel flow paths 230 are formed by being connected between the first meandering flow path 210 and the second meandering flow path 220.

The meandering flow paths 210 and 220 are flow paths that connect the distribution flow path 204 formed in the inlet side and the confluence flow path 205 formed in the outlet side, and refer to flow paths formed by being bent at least twice. In addition, the parallel flow paths 230 are flow paths that connect the distribution flow path 204 and the confluence flow path 205, and refer to flow paths formed without being bent. Accordingly, the meandering flow paths 210 and 220 may be formed to have flow lengths longer than those of the parallel flow paths 230.

For example, if the meandering flow paths 210 and 220 are flow paths formed by being bent twice, and the bent portions 211, 212, 221, and 222 are positions close to the distribution flow path 204 or the confluence flow path 205, the meandering flow paths 210 and 220 may be formed to have flow lengths approximately three times longer than those of the parallel flow paths 230. The distribution flow path 204 is a flow path that distributes the reactants introduced through the inlet 202 to several flow paths 210, 220, and 230, and the confluence flow path 205 is a flow path where the reactants flowing through the flow paths 210, 220, and 230 join and are guided to the outlet 203. In addition, “positions close to” may mean positions spaced apart from the distribution flow path 204 or the confluence flow path 205 by the width of the meandering flow paths 210 and 220.

As the meandering flow paths 210 and 220 are formed to have flow lengths longer than those of the parallel flow paths 230, the meandering flow paths 210 and 220 may be formed to have flow resistances greater than those of the parallel flow paths 230. When the widths of the meandering flow paths 210 and 220 and the parallel flow paths 230 are the same, and the meandering flow paths 210 and 220 are bent twice as shown in FIG. 6, the meandering flow paths 210 and 220 may have flow resistances about 3 times those of the parallel flow paths 230.

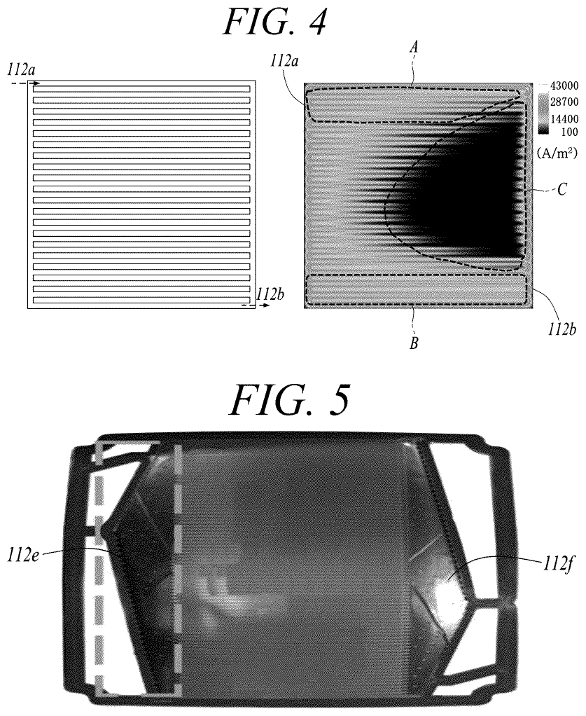

Referring again to FIG. 4, although the reactants flowing into the inlet 112a tend to flow intensively through the parallel flow path region A close to the inlet 112a and the parallel flow path region B close to the outlet 112b, since the first meandering flow path 210 and the second meandering flow path 220, through which reactants flow intensively, are formed to have flow resistances greater than those of the parallel flow paths 230 in an embodiment of the present disclosure, the reactants flown into the inlet 202 can flow more into the parallel flow paths 230 with relatively low flow resistances. Accordingly, compared to the conventional separators 112_1 and 112_2, the reactants are relatively uniformly supplied to the meandering flow paths 210 and 220 and the parallel flow paths 230, thereby making it possible to make the current density distribution uniform.

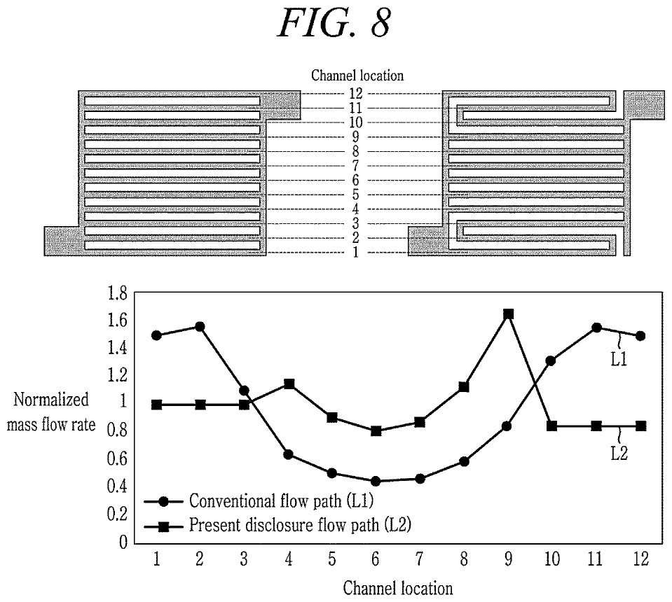

In this regard, description will be made with reference to FIGS. 7 and 8.

FIG. 7 is a drawing for comparing and explaining the current densities in the separator of the related art and the separator for the present disclosure.

(a) of FIG. 7 is a graph showing the fuel cell current density when using the separator 112_2 provided with the flow path having the shape of A in FIG. 4, and (b) of FIG. 7 is a graph showing the fuel cell current density when using the separator 200 provided with the flow path of the present disclosure shown in FIG. 6.

Referring to (a) and (b) of FIG. 7, it can be confirmed that the C region (black region) with low current density is significantly reduced so that the current density in (b) of FIG. 7 is greatly improved.

FIG. 8 is a drawing for comparing and explaining the mass flow rate for each channel in the separator 112_2 of the related art and the separator 200 of the present disclosure.

Referring to FIG. 8, the flow mass flow rate L1 for each channel when using a conventional separator 112_2 is shown to be small in channels 4 to 8, which are the middle region, and large in the remaining regions close to the inlet and outlet, so that it can be confirmed that the reactants are supplied unevenly. In addition, it can be confirmed that the flow mass flow rate L2 for each channel when using the separator 200 provided with the flow path of the present disclosure is even without significant difference in all channels.

According to the above-described embodiment of the present disclosure, it is possible to uniformly supply reactants from all channels without using the distribution flow paths 112e and 112f as shown in FIG. 5. Therefore, it is possible to uniformly supply reactants without increasing the size of the separator, thereby preventing deterioration due to non-uniform current density distribution.

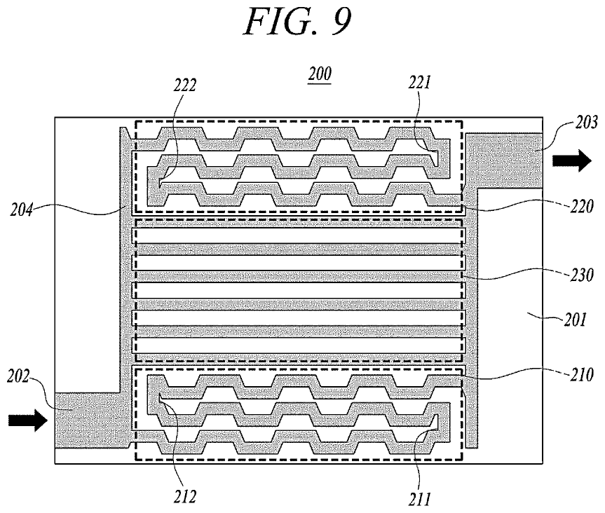

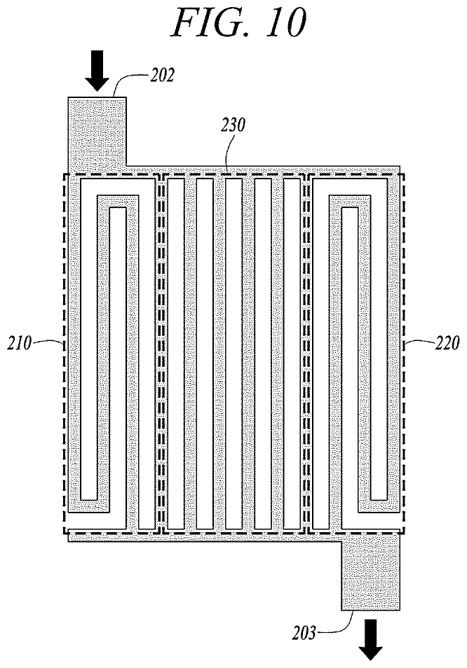

Next, a separator according to another embodiment of the present disclosure will be described with reference to FIG. 9. FIG. 9 is a plan view showing a separator according to another embodiment of the present disclosure.

Referring to FIG. 9, the separator 200 according to another embodiment of the present disclosure includes a body plate 201, an inlet 202, an outlet 203, a first meandering flow path 210, and a second meandering flow path 220, and a parallel flow path 230.

Since the separator 200 of this embodiment is substantially the same as that of the above-described embodiment except that the flow paths formed in the first meandering flow path 210 and the second meandering flow path 220 are formed in a zigzag shape, repeated description is omitted.

The first meandering flow path 210 is formed to be connected to the inlet 202, the second meandering flow path 220 is formed to be connected to the outlet 203, and a plurality of parallel flow paths 230 are formed to be connected between the first meandering flow path 210 and the second meandering flow path 220.

In this embodiment, the meandering flow paths 210 and 220 are flow paths formed by being bent at least twice, and each flow path may be formed in a zigzag shape to further increase the flow resistance of the entire meandering flow paths 210 and 220, thereby allowing the reactants to be distributed in larger quantities through the plurality of parallel flow paths 230.

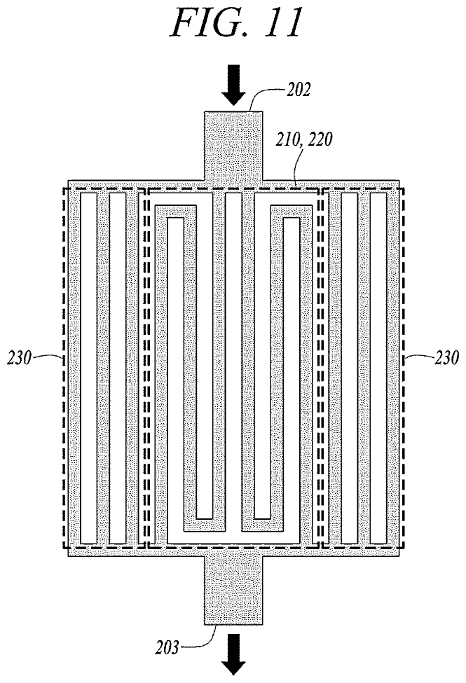

FIGS. 10 and 11 are plan views conceptually illustrating application examples of separators according to embodiments of the present disclosure.

The above-described embodiments illustrate that the flow paths 210, 220, and 230 are formed in the horizontal direction, but the present disclosure is not limited thereto, and the flow paths 210, 220, and 230 as shown in FIGS. 10 and 11 may be formed in the vertical direction. In this case, the inlet 202 may be formed in one side of the upper or lower part, and the outlet 203 may be formed in the opposite side thereof.

In addition, the above-described embodiments illustrate that the parallel flow path 230 is formed between the first meandering flow path 210 and the second meandering flow path 220, but the present disclosure is not limited thereto, and as shown in FIG. 11, the first meandering flow path 210 and the second meandering flow path 220 are formed as one group, and the parallel flow paths 230 may be formed in both sides of the meandering flow paths 210 and 220. In this case, the inlet 202 may be formed in the center of the upper or lower part, and the outlet 203 may be formed at a position opposite to the inlet 202.

Hereinabove, one embodiment of the present disclosure has been described, but those skilled in the art may modify and change the present disclosure in various ways by attachment, change, deletion or addition of components without departing from the spirit of the present disclosure as set forth in the patent claims, and this will also be included within the scope of the rights of the present disclosure.

What is claimed is:

1. A separator for a fuel cell, the separator comprising:
a body plate;
an inlet formed in one side of the body plate;
an outlet formed in the other side of the body plate;
a first meandering flow path formed by being connected to the inlet;
a second meandering flow path formed by being connected to the outlet; and
a parallel flow path formed between the first meandering flow path and the second meandering flow path.

2. The separator for a fuel cell of claim 1, wherein the first meandering flow path and the second meandering flow path are formed to have a flow resistance greater than that of the parallel flow path.

3. The separator for a fuel cell of claim 1, wherein the first meandering flow path and the second meandering flow path are formed to have a flow length longer than that of the parallel flow path.

4. The separator for a fuel cell of claim 1, wherein the first meandering flow path and the second meandering flow path are flow paths that connect a distribution flow path formed in the inlet side and a confluence flow path formed in the outlet side, and are formed by being bent at least twice, and the parallel flow path is a flow path that connects the distribution flow path formed in the inlet side and the confluence flow path formed in the outlet side, and is formed without being bent.

5. The separator for a fuel cell of claim 1, wherein the first meandering flow path and the second meandering flow path are flow paths formed in a zigzag shape connecting the distribution flow path formed in the inlet side and the confluence flow path formed in the outlet side, and are formed by being bent at least twice.

6. A separator for a fuel cell, the separator comprising:
a body plate;
an inlet formed in the center of one side of the body plate;
an outlet formed in the other side of the body plate at a position opposite to the inlet;
a meandering flow path formed by being connected to the inlet and the outlet; and
parallel flow paths formed in both sides of the meandering flow path.

7. The separator for a fuel cell of claim 6, wherein the meandering flow path is formed to have a flow resistance greater than those of the parallel flow paths.

8. The separator for a fuel cell of claim 6, wherein the meandering flow path is formed to have a flow length longer than those of the parallel flow paths.

9. The separator for a fuel cell of claim 6, wherein the meandering flow path is a flow path that connects the distribution flow path formed in the inlet side and the confluence flow path formed in the outlet side, and is formed by being bent at least twice, and the parallel flow paths are flow paths that connect the distribution flow path formed in the inlet side and the confluence flow path formed in the outlet side, and are formed without being bent.

10. A fuel cell comprising:
a membrane-electrode assembly including a cathode electrode, an anode electrode, and a membrane between the cathode electrode and the anode electrode; a cathode electrode separator which is stacked on the membrane-electrode assembly and in which a flow path for air or oxygen is formed; and a gas diffusion layer interposed between the cathode electrode separator and the membrane-electrode assembly, wherein the cathode electrode separator is the separator of claim 1.
